(19) United States
(12) Patent Application Publication
(10) Pub. No.: US 2018/0197701 A1
(43) Pub. Date: Jul. 12, 2018

(54) LUMINOUS KEYBOARD

(71) Applicant: Primax Electronics Ltd., Taipei (TW)

(72) Inventor: CHE-WEI YANG, Taipei (TW)

(21) Appl. No.: 15/596,150

(22) Filed: May 16, 2017

(30) Foreign Application Priority Data
Jan. 6, 2017 (TW) 106100442

(51) Int. Cl. H01H 13/83; H01H 3/12

(52) U.S. Cl. CPC H01H 13/83; H01H 2231/002; H01H 2219/06; H01H 3/125

(57) ABSTRACT

The present invention provides a luminous keyboard, including a key cap, a frame plate, and a light source. The frame plate is provided between the key cap and the light source for shielding light generated by the light source. The frame plate includes a plurality of openings for the light to pass through, and each opening is provided below the key cap. When the light passes through the opening, the light is illuminated on the key cap and the key cap is enabled to shine. In order to avoid the light being leaked out between the key cap and the opening of the frame plate, the opening is smaller than the press portion of the key cap.

### FIELD OF THE INVENTION

The present invention relates to a luminous keyboard, and particularly to a luminous keyboard of which an opening of a frame plate is smaller than a press portion of a key cap.

### BACKGROUND OF THE INVENTION

In order to enable a user to use a keyboard conveniently in a place without enough light, a luminous keyboard is launched in the market. A light source is provided within the luminous keyboard to illuminate keys, so that characters or symbols on the keys are easily identified.

Referring to FIG. 1, and FIG. 1 is a schematic diagram of a generally known luminous keyboard. As shown in FIG. 1, a generally known luminous keyboard 10 includes a plurality of keys 11 (only FIG. 1 merely shows a single key 11), a frame plate 12, a switch circuit board 13, a bottom plate 14, and a light source 15. Each key 11 includes a key cap 16, a support assembly 17, and an elastic body 18. Moreover, the frame plate 12 includes a plurality of openings 121. The frame plate 12, the switch circuit board 13, the bottom plate 14, and the light source 15 are sequentially provided below the key cap 16 from top to down.

More detailed, one end of the support assembly 17 of the key 11 is connected to the key cap 16, and the other end passes through the openings 121 of the frame plate 12 to be connected to a hook of the bottom plate 14. Therefore, the key cap 16 is fixed on the bottom plate 14 by using the support assembly 17. While being pressed, the key cap 16 moves towards the frame plate 12 to press the elastic body 18, so as to deform the elastic body 18 and trigger the switch circuit board 13 to generate a switch signal. When the key cap 16 is not pressed, the elastic body 18 helps the key cap 16 to back to an original position.

The light source 15 is provided below the bottom plate 14 for generating light to illuminate the key 11. The light source 15 includes an LED 151 and a light guide plate 152, and an upper surface of the light guide plate 152 is provided with a microstructure 153. In addition, the LED 151 is located at one side of the light guide plate 152. After the LED 151 generates light, the light enters the light guide plate 152 to be transmitted. The microstructure 153 is used to change a path of the light, so that the light leaves the light guide plate 152 to passes through the openings 121 of the frame plate 12 upwardly, thereby illuminating the key cap 16 to enable the key 11 to shine.

Although the light source 15 of the generally known luminous keyboard 10 can illuminate the key 11, the light of the light source 15 is easy to be leaked out from the openings 121 of the frame plate 12. As a result, halation is generated surrounding the key cap 16, so as to add visual disturbance. Therefore, how to solve light leakage becomes a problem needing to be urgently solved. In order to solve the foregoing problem, a luminous keyboard is needed to improve the generally known deficiencies.

### SUMMARY OF THE INVENTION

A main objective of the present invention is providing a light-leakage-proof luminous keyboard. In a preferred embodiment, the present invention provides a luminous keyboard, including:

a light source; and

a plurality of keys, located above the light source, and the light source illuminating the plurality of keys, where each one of the plurality of keys includes:

a key cap, having a press portion and a key skirt;

a support assembly, connected to the key cap and supporting the key cap; and

a frame plate, located between the key cap and the light source, and for shielding a light of the light source, where the frame plate includes:

a plurality of openings, for the support assembly to pass through the frame plate, where any one of the plurality of openings is smaller than the press portion of the key cap, thereby avoiding the light being leaked out between the key cap and the opening; and

a plurality of annular grooves, where the plurality of annular grooves are provided surrounding the plurality of openings, when the press portion of the key cap is pressed, the key cap moves towards the frame plate, and the key skirt of the key cap is accommodated in any one of the plurality of annular groove.

In a preferred embodiment, the key skirt has a height, the annular groove has a depth, and the depth of the annular groove is greater than or equal to the height of the key skirt.

In a preferred embodiment, the opening has four side walls, and at least one of the side walls is a light-reflective wall for reflecting the light.

In a preferred embodiment, the frame plate is a housing of a notebook computer.

In a preferred embodiment, the frame plate is an opaque frame plate.

In a preferred embodiment, the support assembly is a scissor foot.

In a preferred embodiment, the light source is a backlight module.

In a preferred embodiment, the luminous keyboard further includes:

a switch circuit board, located below the frame plate, and for generating a switch signal; and

a bottom plate, located below the switch circuit board, and for fixing the support assembly.

### BRIEF DESCRIPTION OF THE DRAWINGS

FIG. 1 is a schematic diagram of a generally known luminous keyboard;

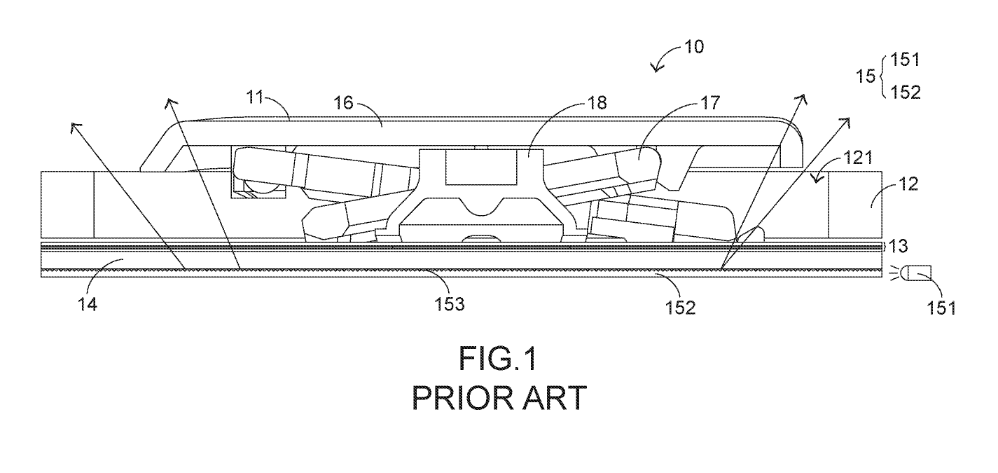

FIG. 2 is a schematic diagram of a luminous keyboard according to the present invention;

FIG. 3 is an exploded view of a luminous keyboard according to the present invention;

FIG. 4 is a sectional view of a luminous keyboard according to the present invention; and

FIG. 5 is a schematic diagram of pressing of a luminous keyboard according to the present invention;

### DETAILED DESCRIPTION OF THE PREFERRED EMBODIMENT

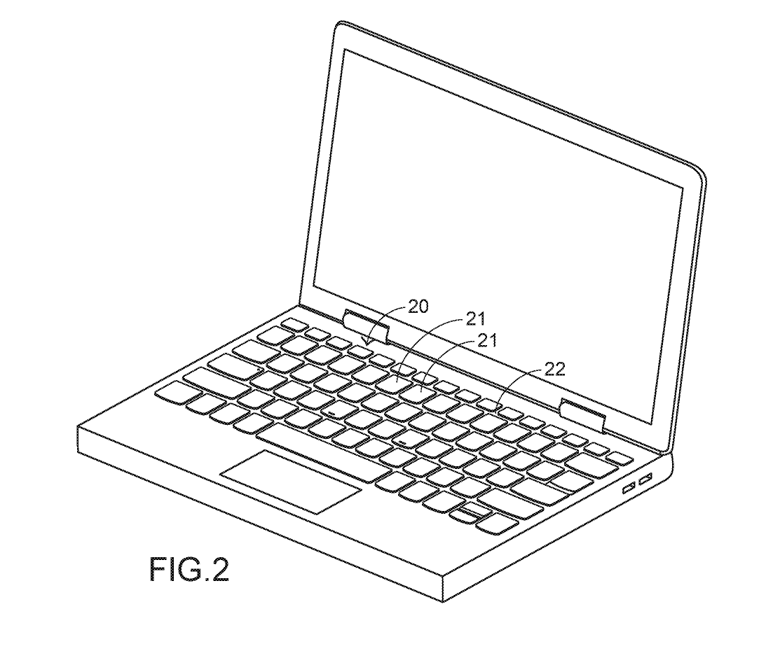

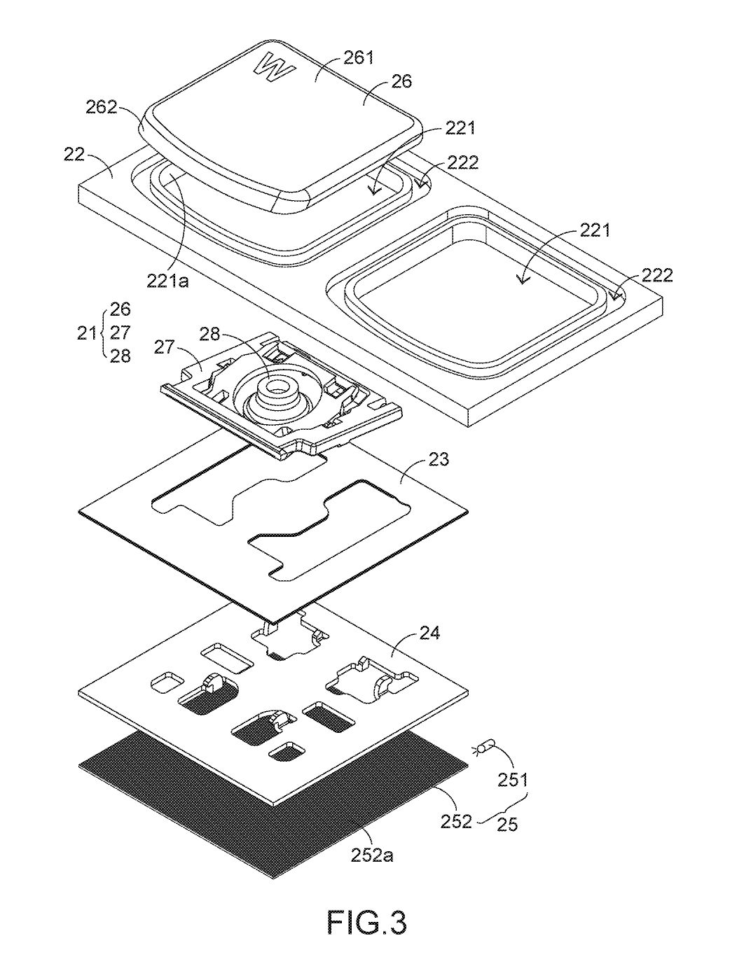

Referring to FIG. 2 and FIG. 3, and FIG. 2 is a schematic diagram of a luminous keyboard according to the present invention; and FIG. 3 is an exploded view of a luminous keyboard according to the present invention. As shown in FIG. 2 and FIG. 3, a luminous keyboard 20 includes a plurality of keys 21, a frame plate 22, a switch circuit board 23, a bottom plate 24, and a light source 25. Each key 21 includes a key cap 26, a support assembly 27, and an elastic body 28. Moreover, each key cap 26 has a press portion 261 and a key skirt 262.

The press portion 261 is located at a top portion of the key cap 26 for a user to contact and press. The key skirt 262 is provided surrounding the press portion 261. The plurality of keys 21 are separately fixed on the bottom plate 24, and the frame plate 22, the switch circuit board 23, the bottom plate 24, and the light source 25 are sequentially provided below the key cap 26 from top to down.

The frame plate 22 is located between the key cap 21 and the light source 25, and is covered at a gap between a key 21 and another key 21. Therefore, light generated by the light source 25 may be shielded, and the light may be avoided from leaking out from the gap between a key 21 and another key 21. In this preferred embodiment, the frame plate 22 is an opaque frame plate, and may be a housing of a notebook computer, but is not limited thereto. In addition, the frame plate 22 is an opaque frame plate made of an opaque material, or is an opaque frame plate made of a translucent plate body having a light shielding coating layer.

The frame plate 22 has a plurality of openings 221 and a plurality of annular grooves 222, where each opening 221 is provided below each key cap 26, and each annular groove 222 is provided surrounding the each opening 221. In this preferred embodiment, the opening 221 is a square opening, the annular groove 222 is a square annular groove, and the opening 221 has four side walls 221a.

The switch circuit board 23 is located below the frame plate 22 for generating a switch signal. In this preferred embodiment, the switch circuit board 23 is a membrane switch circuit, and a membrane of the membrane switch circuit is transparent. Therefore, the light may pass through the membrane switch circuit to be transmitted upwardly. The bottom plate 24 is located below the switch circuit board 23 for fixing the plurality of keys 21.

Subsequently, methods for combining and fixing an assembly of the keys 21 are described. As shown in FIG. 3, the support assembly 27 is provided below the key cap 26 to support the key cap 26. One end of the support assembly 27 is connected to a lower surface of the key cap 26, and the other end of the support assembly 27 passes through the openings 221 of the frame plate 22 to be connected to a hook of the bottom plate 24. Therefore, the key cap 26 is fixed on the bottom plate 24 by using the support assembly 27. In this preferred embodiment, the support assembly 27 is a scissor foot, but is not limited thereto.

The elastic body 28 is provided between the key cap 26 and the switch circuit board 23, so as to provide an elastic force for the key cap 26 to reset. When the key cap 26 is pressed, the elastic body 28 is deformed because of being pressed by the key cap 26, where elastic energy is accumulated; and the switch circuit board 23 is triggered to generate the switch signal. When the key cap 26 is not pressed, the elastic body 28 releases the elastic energy, so as to drive the key cap 26 to stay away from the frame plate 22 to back to the original position.

The light source 25 is provided below the bottom plate 24 for illuminating the key 21. In this preferred embodiment, the light source 25 is a backlight module, but is not limited thereto. In other preferred embodiments, the light source 25 may be a plurality of LEDs. The a plurality of LEDs are provided on the switch circuit board 23, and each LED is located below each key 21 and illuminates the each key 21, respectively.

The light source 25 below uses a backlight module as an example. The light source 25 includes at least one LED 251 and a light guide plate 252, where the LED 251 may be provided at a side of the light guide plate 252, or be provided in a through hole of the light guide plate 252. After light generated by the LED 251 enters the light guide plate 252, the light is continuously totally reflected in the light guide plate 252. Therefore, the light is evenly distributed in the light guide plate 252.

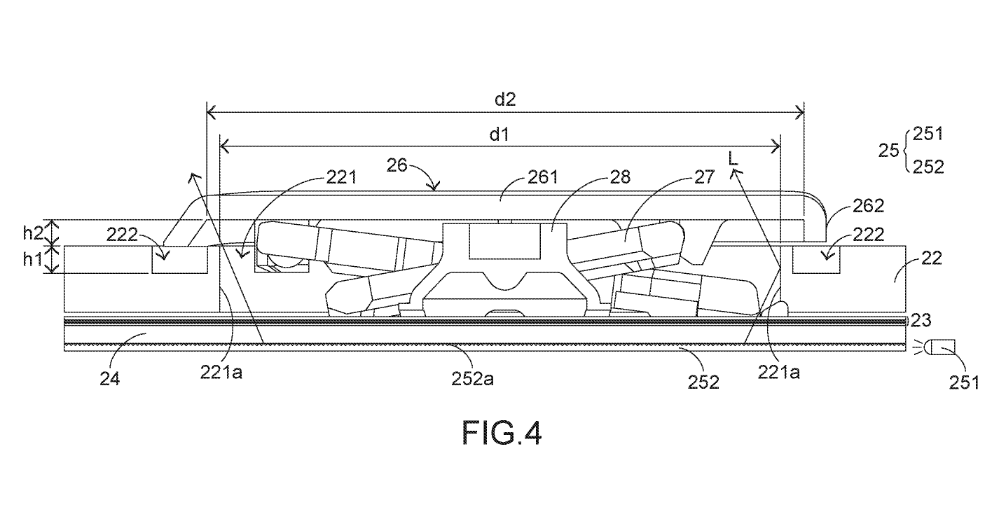

Referring to FIG. 4, and FIG. 4 is a sectional view of a luminous keyboard according to the present invention. As shown in FIG. 4, after the light of the LED 251 enters the light guide plate 252, the light is evenly distributed in the light guide plate 252. When a path of the light is changed because the light is affected by light guide ink of the light guide plate 252 or a microstructure 252a, the light leaves the light guide plate 252 and passes through a light-transmitting area (not shown in the figure) of the bottom plate 24 upwardly, and then passes through the opening 221 of the frame plate 22 to illuminate the key cap 26. The light-transmitting area of the bottom plate 24 is a light-transmitting hole, but is not limited thereto.

It should be noted that a side length of the opening 221 of the frame plate 22 is a first length d1, a side length of a press portion 261 of the key cap 26 is a second length d2, and the first length d1 is smaller than the second length d2. In this way, the opening 221 of the frame plate 22 is smaller than the press portion 261 of the key cap 26. Therefore, when the light passes though the opening 221 of the frame plate 22, it is not easy for the light to be leaked out between the key cap 26 and the opening 221, thereby being able to avoid halation being generated surrounding the key cap 26.

In order to increase a utilization rate of the light, at least one side wall 221a of the opening 221 is a light-reflective wall. For example, the four side walls 221a of the opening 221 are coated with a light-reflective coating layer. After the light enters the opening 221 of the frame plate 22, part of the light L cannot be directly illuminated on the key cap 26, but is illuminated on the side walls 221a of the opening 221. Because the side walls 221a are light-reflective walls, the light L illuminated on the side walls 221a may be illuminated on the key cap 26 after being total reflected by the side walls 221a. In this way, the light L which cannot be directly illuminated on the key cap 26 would not be wasted.

In addition, the annular groove 222 of the frame plate 22 is provided surrounding the opening 221, and is located below the key skirt 262 of the key caps 26, so as to accommodate the key skirt 262 of the key caps 26. A distance from an upper surface of the frame plate 22 to a bottom portion of the annular groove 222 is a depth of the annular groove 222, and the depth of the annular groove 222 is a first distance h1. A distance from a lower surface of the key cap 26 to a bottom portion of the key skirt 262 is a height of the key skirt 262, and the height of the key skirt 262 is a second distance h2. The first distance h1 is greater than or equal to the second distance h2. The depth of the annular groove 222 is greater than or equal to the height of the key skirt 262, and therefore, the annular groove 222 is able to accommodate the key skirt 262 of the key cap 26.

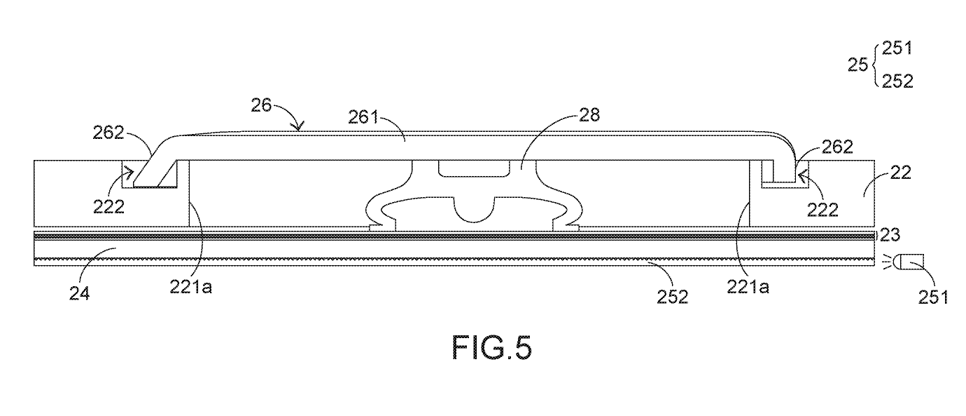

Referring to FIG. 5, and FIG. 5 is a schematic diagram of pressing of a luminous keyboard according to the present invention. As shown in FIG. 5, when the press portion 261 of the key cap 26 is pressed, the key cap 26 moves towards the frame plate 22, so as to press the elastic body 28. At this time, the key skirt 262 of the key cap 26 enters the annular groove 222 of the frame plate 22 and is accommodated therein. In this way, the key skirt 262 of the key cap 26 would not hit against the frame plate 22, so that the frame plate 22 would not affect a pressing process of the keys 21.

It can be known from the foregoing description of the preferred embodiments that a frame plate of a luminous keyboard of the present invention has an opening, and the opening is smaller than a press portion of a key cap. In this way, the frame plate avoids light being leaked out between the key cap and the opening, thereby solving the problem that halation is generated surrounding the key cap. In addition, an annular groove is provided surrounding the opening to accommodate a key skirt of the key cap, so as to be able to prevent the key cap from hitting against the frame plate. Therefore, the pressing process of a key would not be affected by the frame plate.

The foregoing is merely the preferable embodiments of the present invention, and is not intended to limit the scope of the present invention. Therefore, any other equivalent replacement or modification made without departing from the spirit disclosed by the present invention shall fall within the scope of the present invention.

What is claimed is:

1. A luminous keyboard, comprising:
a light source;
a plurality of keys, located above the light source, and the light source illuminating the plurality of keys, wherein each one of the plurality of keys comprises:
a key cap, having a press portion and a key skirt; and
a support assembly, connected to the key cap and supporting the key cap; and
a frame plate, located between the key cap and the light source, and for shielding light of the light source, wherein the frame plate comprises:
a plurality of openings, for the support assembly to pass through the frame plate, wherein any one of the plurality of openings is smaller than the press portion of the key cap, thereby avoiding the light being leaked out between the key cap and the opening; and
a plurality of annular grooves, wherein the plurality of annular grooves are provided surrounding the plurality of openings, when the press portion of the key cap is pressed, the key cap moves towards the frame plate, and the key skirt of the key cap is accommodated in any one of the plurality of annular grooves.

2. The luminous keyboard according to claim 1, wherein the key skirt has a height, the annular groove has a depth, and the depth of the annular groove is greater than or equal to the height of the key skirt.

3. The luminous keyboard according to claim 1, wherein the opening has four side walls, and at least one of the side walls is a light-reflective wall for reflecting the light.

4. The luminous keyboard according to claim 1, wherein the frame plate is a housing of a notebook computer.

5. The luminous keyboard according to claim 1, wherein the frame plate is an opaque frame plate.

6. The luminous keyboard according to claim 1, wherein the support assembly is a scissor foot.

7. The luminous keyboard according to claim 1, wherein the light source is a backlight module.

8. The luminous keyboard according to claim 1, wherein the luminous keyboard further comprises:
a switch circuit board, located below the frame plate, and for generating a switch signal; and
a bottom plate, located below the switch circuit board, and for fixing the support assembly.
